(19) United States
(12) Patent Application Publication
(10) Pub. No.: US 2019/0172126 A1
(43) Pub. Date: Jun. 6, 2019

(54) PROGRAM FOR LEASED VEHICLE ASSET PROTECTION

(71) Applicant: AutoXcel Corporation, Wilmington, NC (US)

(72) Inventor: Mark G. Evans, Wilmington, NC (US)

(21) Appl. No.: 15/829,177

(22) Filed: Dec. 1, 2017

(51) Int. Cl. G06Q 30/06

(52) U.S. Cl. CPC G06Q 30/0645

(57) ABSTRACT

A method for providing guaranteed asset protection for leased vehicles in which the dealer acts as the agent at the time of lease promises a future credit of all or part of the down payment in the event of total loss. In one embodiment of the program, the dealer assigns the program contract and the credit obligation to the lessor. In a second embodiment of the program, the dealer makes the promise to the lessee to provide the credit. In a third embodiment of the program, a lessee can obtain an optional extended term in which the lessor provides a replacement vehicle of similar or same make and model, and extends the term of the lease for a predetermined term extension. The lease term extension corresponds to the numbers of months of the lease that have expired at the time of loss up to a maximum predetermined term extension.

### RELATED APPLICATIONS

This application is a continuation of U.S. Non-Provisional application Ser. No. 14/597,963 filed 15 Jan. 2015, which claims the benefit of U.S. Provisional Patent Application Ser. No. 61/928,291, filed 16 Jan. 2014, and U.S. Provisional Patent Application Ser. No. 61/981,285, filed 18 Apr. 2014, each of which is incorporated by reference in its entirety herein, and for all purposes.

### TECHNICAL FIELD

Embodiments of the invention generally relate to providing guaranteed vehicle asset protection and, more particularly, to techniques for protection of debtors and creditors in lease agreements for vehicles.

### BACKGROUND

Various independent vendors sell finance and insurance (“F&I”) programs and products at car dealerships. The vendors make their sales through independent agents who represent the product to the particular dealer. The dealer then has to convince the person that buys a car to accept programs such as Guaranteed Asset Protection (GAP), vehicle mechanical extended maintenance or a product warranty for the car being purchased. Programs sold in finance and insurance departments of dealerships are viewed differently by state insurance departments on a state by state basis.

Typically, a finance and insurance program promises to repair or replace an item based on the breakdown of the item or due to a future fortuitous event. The promise to make a repair or to replace an item due to a fortuitous event is, on its face, a promise of insurance and would normally be regulated by a given state's Department of Insurance, Property & Casualty division. There are some exceptions, however, which take a program out of being considered as insurance. The removal from insurance consideration permits a program to be sold at the dealership without having a licensed agent on hand, filed in rates and filed in contracts at the state insurance department. Some exceptions to falling under the insurance umbrella include vehicle service contracts, debt cancellation programs, product warranty programs, and roadside assistance programs, as described in more detail below:

### Vehicle Service Contracts (“VSC”)

VSC programs promise a repair or replacement due to wear. This exception began with repair and replacement of engines and drive trains but has been extended to include repair and replacement of items that really are not due to the wear of the item but rather to some other event. For example, there are dent repair programs and windshield repair programs that have been permitted in some states as VSC exceptions.

### Debt Cancellation Programs

One example of a debt cancellation program is Guaranteed Asset Protection (GAP) waiver which provides that a promise made by a creditor to waive the difference between the value of a car as depreciated and the amount of a loan is not insurance. In actuality there is no guaranteed asset protection other than the fact that the consumer's money in his pocket or in the bank is not going to be touched. The theory that some states have followed to permit the GAP program is that the agreement is between creditor and debtor and, therefore, falls outside of insurance. In some instances the promise to make up the difference is guaranteed by an insurer.

### Product Warranty Programs

The typical example of a product warranty program is the paint and fabric program. Liquid is applied to the outside of the car and another liquid is applied to the inside of the car and, the promise is made that the applied chemical will stop or retard paint fade, clear coat loss, and acid rain damage on the outside of the vehicle, and stains, ripping, and tearing on the inside of the vehicle. Some of these programs have been extended to make claims of strengthening windshields and even more.

### Roadside Assistance (Motor Clubs) Programs

Another exception to finance and insurance programs is the idea of minor roadside assistance. Needing a tow, needing a tire change, or replacing a blown radiator hose are examples of vehicle emergencies included in a motor club roadside assistance program. Several vendors attempt to extend the roadside exception to tire and wheel repair which is viewed by most states as a fortuitous (chance) event and not related to the breakdown of an item. Key replacement is frequently permitted as an appropriate motor club function. The argument is that the motor club members are entitled to certain benefits as part of a club membership.

### SUMMARY

The embodiments disclosed are directed to methods and techniques for protection of debtors (lessees) and creditors (lessors) in lease agreements for vehicles. In one embodiment, the lease protection program that may be offered as lease down payment protection must be structured so as to place the program into a category that would not be considered selling insurance. Although an implementer of an exemplary embodiment may have licenses in various states related to vehicle service contracts and/or GAP, it is important that the implementer have a thorough understanding of these exception programs in the states in which the implementer operates.

In an exemplary program embodiment, the dealer acting as the Lessor's agent at the time of vehicle lease promises a future credit of the original amount paid by the lessee, based on a mathematical formula in the event of total loss. In one embodiment of the program, the dealer assigns the program contract and the credit obligation to the lessor. In another embodiment of the program, the dealer makes the promise to the lessee to provide the credit. In a third embodiment of the program, the lessee is granted an option to extend or renew the term of the existing lease after a total vehicle loss with a substitution of the leased vehicle that is the same or a similar model vehicle available at the time of total loss.

### BRIEF DESCRIPTION OF THE DRAWINGS

These and other advantages and aspects of the embodiments of the disclosure will become apparent and more readily appreciated from the following detailed description of the embodiments taken in conjunction with the accompanying drawings, as follows.

FIG. 1 illustrates a program_arrangement wherein the lessor provides credit to the lessee to provide protection against a total vehicle loss in accordance with an exemplary embodiment.

FIG. 2 illustrates a program arrangement wherein the vehicle dealer provides credit to the lessee to provide protection against a total vehicle loss in accordance with an exemplary embodiment.

FIG. 3 illustrates a program arrangement wherein the lessee activates an option to extend the lease with a replacement vehicle of substantially the same make and model as originally leased.

### DETAILED DESCRIPTION

The following detailed description is provided as an enabling teaching of embodiments of the invention. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the invention and not in limitation thereof, since the scope of the invention is defined by the claims.

Various asset protection programs have been proposed for either the purchase or lease of vehicles. For example, a guaranteed asset protection waiver, also known as a GAP or GAP waiver, is defined under state laws as a contractual agreement wherein a creditor agrees for a separate charge to cancel or waive all or part of amounts due on a borrower's finance agreement in the event of total physical loss or uncovered theft of the purchased motor vehicle. The GAP waiver must be part of a separate addendum to the finance agreement. GAP waivers may be sold for a single payment at the time of the vehicle purchase, or may be offered with a monthly or periodic payment option.

Unfortunately, however, not many products are typically available for an automotive retail seller's finance and insurance department to offer to the auto leasing customer, as opposed to the auto buying customer. One such proposed auto leasing program solution would provide for a replacement of the down payment (i.e., the amount due at signing or delivery of the vehicle) that many lease customers have to or chose to provide. For example, in the northeast portions of the country and in many more urban areas, lease customers will often pay several thousand dollars at the time of leasing a vehicle in order to qualify for the lease's monthly payments. It is not uncommon for lease customers in more affluent areas to pay $5,000 to $15,000 for a 36, 39, 48 or 51 month lease. Essentially, the prospect of leasing and operating the luxury car approximately every three years is worth the large down payment to the vehicle lessee. In some proposed schemes, the lessee can be repaid the down payment amount or some percentage of it. In one scheme, the lessee would be repaid an amount that is up to 1.5 times the down payment. While it would make for a great sales program for leases, in reality such a program would have little or no chance of being insured by an insurer in the finance and insurance industry space. This be because insurers are not likely to insure a sum of money that the customer never paid unless it could be rationally related to some out-of-pocket expense incurred by the customer at the time of the lease.

Another proposed solution for lease programs is a replacement lease program, in which the lessor could pay the insurer directly to insure a credit for the full down payment related to certain benefits of a lease. In this proposal, the provider would look to convince lessors to prepay an insured program to permit the lessor a credit of some of the lease down payment benefits to permit a replacement lease to the consumer in the event of a total loss. However, from the lessor's standpoint this may not likely be a great benefit since the person typically wanting to lease a car does so for the status of the car and is not lured to the car showroom by virtue of the benefit of insuring the down payment. Furthermore, the additional cost to the lessor entity represents a tremendous volume cost based on the number of vehicles that are leased.

Thus, at one end of the spectrum of products available to offer an auto leasing customer may be a program that refunds a down payment amount plus a factor or multiple of the down payment, such as, for example, up to 1.5 times the down payment. Alternatively, at the other end of the spectrum may a program in which lessors would have to absorb costs for a lease benefit that is not currently perceived as a necessity to the lease.

It is important to understand what the consumer has at risk, which is the use of the value over time of the amount paid by the consumer at the time of signing the lease. The lease customer who puts a great deal down on an auto lease is not expecting equity or return value at the end of the lease. Industry standards for the annual loss frequency rate on GAP waivers ranges from about 0.7 to 1.0 depending upon insurer. In some instances, a primary insurance carrier will pay to the lessee the actual cash value of the car (retail value) which may be over the replacement cost to the lessor thus providing some potential for excess. That sum may be attributed to recover part of the lessee's amount paid at the time of signing the lease.

By viewing the purpose of the down payment and the value of that money over the life of the lease, a formula can be devised that credits the value of the lease down payment money when it otherwise would be at the greatest risk of loss of the intended value, i.e., early in the lease (first year gets a complete repayment), but tapering down starting on day 366 of a lease until the lease term ends. This would permit the insurer to lower the proposed rate as the risk drastically diminishes over time. For example, for a lease down payment of $5000 on a 36 month lease, the down payment could be completely repaid to the lessee if the vehicle is a total loss within the first year of the lease. During the second year of the lease, the lease down payment could be credited from as much as 99% of the amount to 50% at the end of that second year on the lease. If the total loss occurred during the third year of the lease, from approximately 49% of the down payment to approximately 1% on the last day of the lease could be repaid to the lessee. Other options can be provided that could depend, for example, on the length of the lease term and the preferred coverage requested by the lessee which could be a price option available in the program.

In exemplary embodiments, a plurality of contract forms have been created that operate to enable a lease-shield or lease-renew program while attempting to be classified as one of the exceptions described above, specifically debt protection relief. In short, these lease-renew programs emulate GAP coverage but for an auto lease. The lessee purchases the lease-shield or lease-renew protection which could be incorporated into the lease payments if disclosed under applicable federal regulations. Like GAP, the idea is to provide a credit so the consumer does not have to pay any out of pocket costs in the event of a total loss. In another embodiment, the lessee could be provided with an optional extension or renewal of the existing lease term and a replacement of the vehicle in the event of total vehicle loss. There would be an additional charge to the lessee for this option.

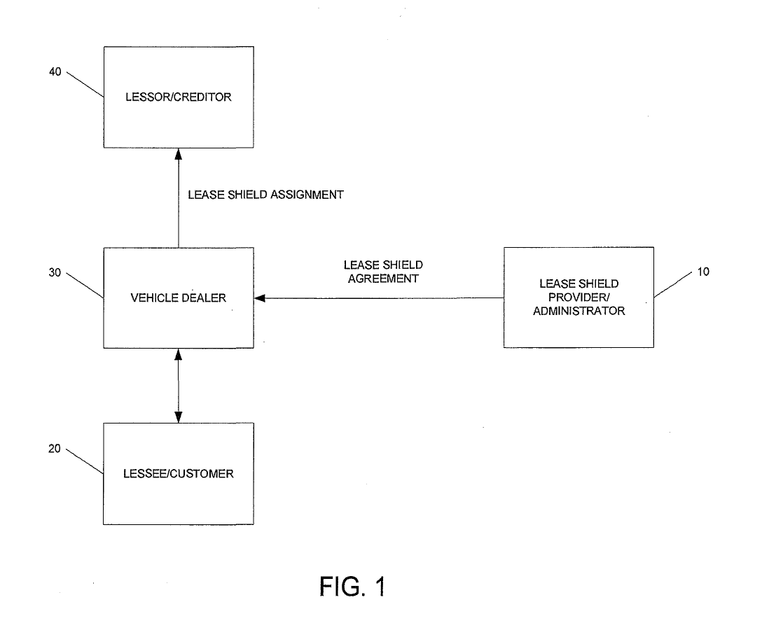

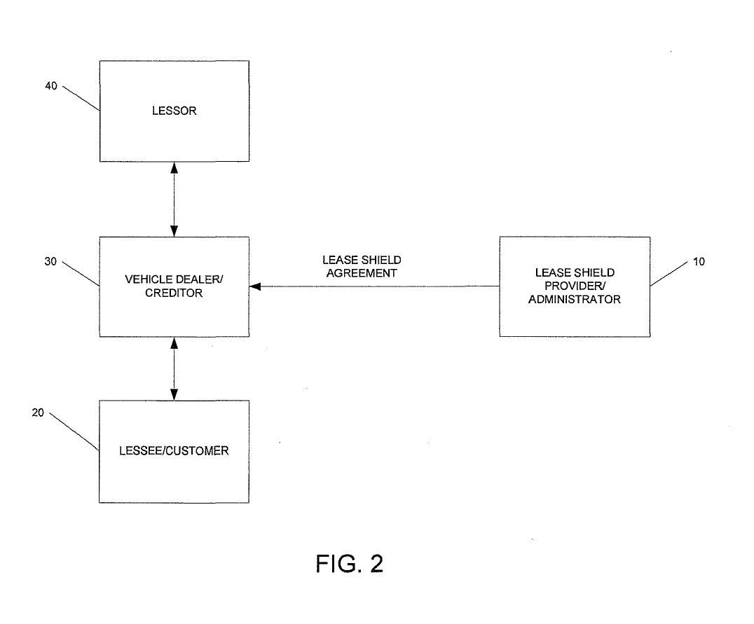

In exemplary program embodiments, the dealer acting as the agent at the time of lease promises a future credit of all or part of the down payment in the event of total loss or the promise of an extended term of the lease and replacement of the leased vehicle. In one embodiment of the program arrangement, as illustrated in FIG. 1, the vehicle dealer 30 receives the program agreement from the administrator 10 and offers the agreement to the lessee 20. Upon acceptance by lessee 20 and lessor 40, the dealer 30 assigns the executed contract and the credit obligation to the lessor 40. The lessor 40 has to accept the assignment of the Lease GAP waiver (LGAP) from the dealer 30 at the time of making the lease, just as a creditor accepts a GAP waiver at the time of making a vehicle sale. In a second embodiment of the program arrangement, as illustrated in FIG. 2, the vehicle dealer 30 receives the program agreement from the program administrator 10 and makes the promise to the lessee 20 to provide the credit.

The structure of the assignment of the program agreement by the dealer 30 to the lessor 40 follows the typical lease contract placement. The dealer 30 typically is only an agent for the lessor 40. The dealer 30 keeps the down payment or trade in and uses that sum to lower the cost of the car upon sale of the car to the lessor who in turn leases the car to the lessee.

Some states view the creditor/debtor arrangement of the lease-renew program as being outside of insurance, so the argument regarding the lease parties is that the lessor 40 is nothing more than a creditor in a lease and the lessee/customer 20 is paying the lessor/creditor 40 over the life of the lease. In making this argument, some states accept, or do not object to, the idea that the program can act like the GAP program does for purchased vehicles and falls outside of the requirements of insurance regulation. In the version of the program_wherein the dealer 30 gives the credit to the lessee 20, there is no need to approach a lessor 40 about assignment.

In making decisions about the program agreement, the states will generally divide into three groups:

a) States in group I will view program as insurance and require the provider to file forms and rates with the state insurance department with the insurer acting directly on the program contract;

b) States in group II will view program as lessor credit and the state insurance department will not regulate the program as it deems it to be a debt relief program similar to GAP; and

c) States in group III will not regulate but will determine that the program is outside of insurance regulations and is likely outside of state financial regulations as well.

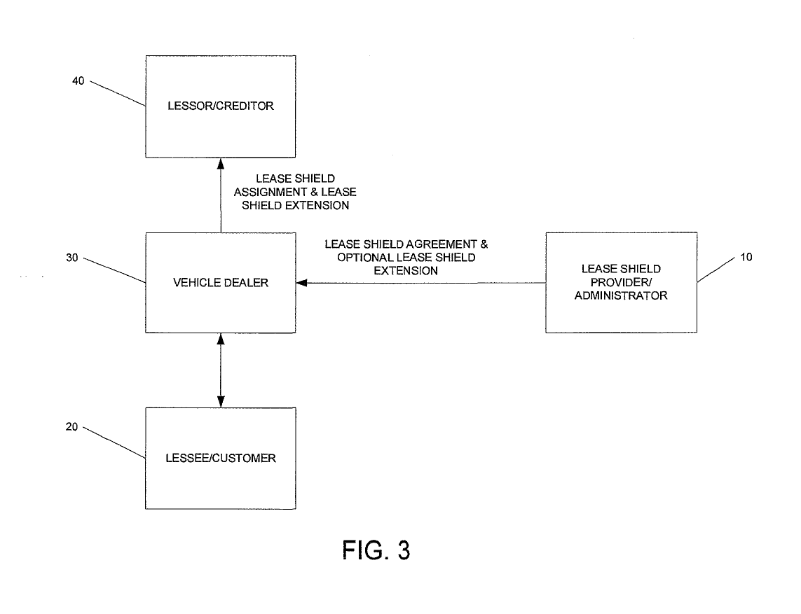

In a third embodiment of the program arrangement, as illustrated in FIG. 3, at the option of the lessee 20, the original lease term can be extended by the number of months that have expired in the lease contract up to a predetermined limit (e.g., first 12 months or first 24 months). Several states have indicated that the “credit” provided by the lessor 40 is not insurance, as a lessor and lessee can mutually contract to extend the term of a lease. Those states would not regulate the amendment of a lease to add more months to the term. An example of this embodiment follows assuming an optional lease extension of 12 months has been agreed to by the lessee 20.

The lessee 20 makes an agreement for a program Extended Term which protects the lessee 20 during the first 12 months of the lease. In the event of a total loss during the first 12 months of the lease, the lessee 20, after acquiring the program Extended Term, has the option of continuing the lease by adding the amount of the lease term that has elapsed to the end of the current lease, with the substitution of a new replacement vehicle of the same model and make currently available. The lessee 20 would have to accept continuation of the lease in writing and provide proof of insurance for the new replacement vehicle to the original extent required by the lessor 40. The lessee 20 would also have to provide proof that his credit rating has not decreased by more than a predetermined amount (e.g., 20%). The lessee/consumer 20 receives the benefit of not having to make another down payment and receives a new vehicle that has the same or better quality than the original vehicle. The lessee 20 could decide not to continue the lease and to cancel the program Extended Term protection. Pursuant to the same rules used for GAP, the lessee 20 would receive a prorated amount of the original down payment minus an administration fee.

Those skilled in the art will appreciate that many modifications to the exemplary embodiments are possible without departing from the scope of the present invention. In addition, it is possible to use some of the features of the embodiments disclosed without the corresponding use of the other features. Accordingly, the foregoing description of the exemplary embodiments is provided for the purpose of illustrating the principles of the invention, and not in limitation thereof, since the scope of the invention is defined solely by the appended claims

What is claimed is:

1. A method for providing asset protection for leased vehicles, the method comprising:
for a lease agreement for a vehicle having a down payment and a term of incremental time periods, determining at least one future value of the down payment on the lease agreement for at least one incremental time period of the lease agreement;
determining a charge to provide a credit for the at least one future value of the down payment throughout the term of the lease agreement; and
entering into a secondary agreement with a purchaser of the lease agreement to provide a credit to the purchaser in the event of a total loss of the leased vehicle during the term of the lease agreement in return for payment of the charge.

2. The method of claim 1, wherein providing a credit further comprises providing a reimbursement of a portion of the down payment.

3. The method of claim 1, wherein providing a credit further comprises providing a replacement vehicle and an extension to the term of the lease agreement.

4. The method of claim 4, wherein the extension of the term is equivalent to a number of expired incremental time intervals on the lease agreement.

5. The method of claim 4, wherein the extension of the term is equivalent to a number of unexpired incremental time intervals remaining on the lease agreement.

6. The method of claim 1, further comprising assigning the secondary agreement to the lessor of the lease agreement.

7. The method of claim 1, wherein the incremental time periods are months.

8. The method of claim 1, wherein the incremental time periods are years.

9. The method of claim 1, wherein the secondary agreement is a lease renew addendum.

10. The method of claim 1, wherein the future value of the down payment depreciates over the term on the lease.

11. The method of claim 1, wherein the event of a total loss of the vehicle further comprises a constructive total loss or an unrecovered theft of the lease vehicle.

12. The method of claim 1, wherein payment of the charge is incorporated into payments for the lease agreement.

13. The method of claim 1, wherein the secondary agreement is provided by a program administrator to a dealer of the vehicle.
